(19) United States
(12) Patent Application Publication
(10) Pub. No.: US 2005/0002437 A1
(43) Pub. Date: Jan. 6, 2005

(54) Probe for a body cavity

(76) Inventor: Jacob Fraden, La Jolla, CA (US)

Correspondence Address: Jacob Fraden, Advanced Monitors Corp., 6215 Ferris Sq., Suite 125, San Diego, CA, 92121, US

(21) Appl. No.: 10/612,112

(22) Filed: Jul. 2, 2003

(51) Int. Cl. G01J 5/00

(52) U.S. Cl. 374/121

(57) ABSTRACT

A medical probe for collecting signals from a body cavity having a profile which is a combination of an outside frustum shape and the multiple surface cavities or indentations situated on the probe outer surface. The probe outer surface when enveloped by a thin probe cover material forms air pockets, thus reducing thermal conductivity across the probe walls and minimizing negative effects of the lateral heat transfer.

### FIELD OF INVENTION

This invention relates to devices for measuring signals from a body cavity, more specifically to infrared noncontact ear thermometers, primarily intended for medical and veterinary applications.

### DESCRIPTION OF PRIOR ART

There are the information collecting probes of medical instruments intended for insertion into an orifice of a body of a human or animal. The probes may contain components that are sensitive to temperature of the cavity walls. Temperature of the walls may adversely affect performance of such components. An example of an instrument is an infrared (IR) thermometer which is a device capable of measuring temperature without a physical contact with the object of measurement. The measurement is done by detecting intensity of the IR radiation which is naturally emanated from the object's surface. For objects having temperatures in the range between 0 and 100° C., this requires use of sensors for detecting IR radiation in the wavelength from 3 and up to approximately 40 micrometers. Often, IR radiation in this range is called thermal radiation. One example of an IR thermometer is an instant medical ear thermometer which is capable of noncontact temperatures measurement from the tympanic membrane and surrounding tissues of the ear canal of a human or animal.

The probes that are inserted into the ear canals have a variety of shapes depending on a particular application. For all applications, a probe must have a profile suitable for an easy, comfortable and generally deeper insertion into an ear canal. A frustum shape is typical for an IR probe. The exterior wall of a probe in the prior art is made smooth and generally follows the shape of the frustum surface. This is exemplified by U.S. Pat. No. 5,871,279, issued to Mooradian et al. and U.S. Pat. No. 5,487,607 issued to Makita et al. The purpose of the probe is, upon insertion into an ear canal, to receive infrared emission via its inserted end and to transmit it to the IR sensor that is positioned inside the probe or near its opposite end. Since the IR sensor must be protected from spurious thermal signals, it is also a purpose of the probe to thermally insulate its own interior from the ear canal skin. Transmission of heat through the side walls of the probe may be a source of large errors since the IR sensor can't distinguish between heat received in the IR form and that received through the probe side walls from the warm ear skin. Numerous technical solutions have been proposed to minimize conductive heat transfer from the skin to the IR sensor. Examples of the solutions are numerous. One solution is providing an air gap between the probe and the inner components as in U.S. Pat. No. 6,332,090 issued to DeFrank et al. Another solution is an internal heat sink that diverts heat flow from the sensor, as exemplified by U.S. Pat. No. 6,109,782 issued to Fukura et al. And another example of a solution is using a solid core wave guide that has low thermal conductivity as in U.S. Pat. No. 5,368,038 issued to Fraden. These and many other methods add complexity and cost to the instrument and may lead to increase in the probe dimensions which would limit use of the thermometer on small children and animals.

Typically, the IR probes are used in combination with the reusable or disposable probe covers made in form of thin polymer sheaths. These covers are exemplified by U.S. Pat. Nos. Re. 34,599 issued to Suszynski et al. and U.S. Pat. No. 6,347,234 issued to Fraden. A probe cover envelopes the probe and forms a protective physical barrier between the probe surface and the ear canal tissue.

It would be advantageous to develop a durable probe for an IR thermometer that would combine a slim shape that fits snuggly in the ear canal and at the same time has a reduced heat conductivity through it side walls. Apart from the infrared ear thermometers, there may be some other medical probes that need to be inserted into a body cavity such as an ear canal, rectum and other orifices. These probes may also need to have reduced thermal conduction through the probe walls and thus the identical method of thermal insulation may be applicable to these devices as to the ear thermometer probes.

Therefore, it is a goal of this invention to provide a probe that has reduced thermal conductivity through it walls.

It is a goal of this invention to provide a probe that is sturdy and has sufficient mechanical strength.

It is a further goal of this invention to provide a probe that allows for an easy insertion into an ear canal.

And another goal of this invention is to provide a medical probe having slim shape that allows insertion into a small body orifice.

### SUMMARY OF INVENTION

A medical probe for collecting signals from a body cavity having a profile which is combination of an outside frustum shape and the multiple surface cavities or indentations situated on the probe outer surface. The probe outer surface when enveloped by a thin probe cover material forms air pockets, thus reducing thermal conductivity across the probe walls and minimizing negative effects of the lateral heat transfer.

### BRIEF DESCRIPTION OF DRAWINGS

FIG. 1 is a general view of the prior art probe inserted into an ear canal.

FIG. 2 shows a cross-sectional view of the prior art probe.

FIG. 3 depicts an external view of the probe with surface cavities.

FIG. 4 is a cross-sectional view of the probe covered with a probe cover.

FIG. 5 shows a probe with multiple cavities on the surface.

FIG. 6 is a cross-sectional view of an enclosed cavity

### DESCRIPTION OF PREFERRED EMBODIMENT

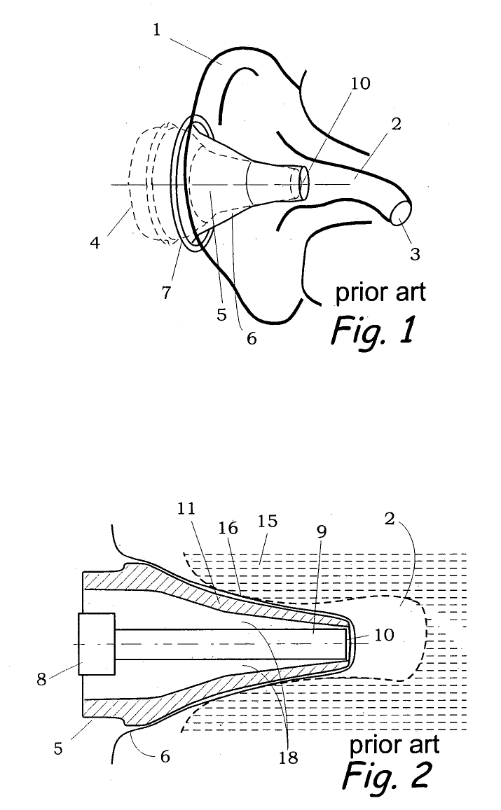

The present invention describes a probe for insertion into a body cavity, such as an ear canal, rectum, mouth and other that may be used for collecting medical signals. However, below we describe a specific probe for of an instant ear thermometer as an example of the most typical application. The probe has a reduced heat transfer through it side walls and thus substantially minimizes effects of the lateral heat transfer through the probe walls. Such a probe may be fabricated of such resins as ABS, nylon, and other plastics having a continuous or foamy structures that may further reduce thermal conductivity. Glass or ceramics also may be employed for fabricating the probe. By way of comparison with prior art, FIG. 1 shows a conventional prior art probe 5 that is attached to the infrared (IR) ear thermometer 4 which is shown here only partially. Probe 5 is covered with probe cover 6 having attachment ring 7. The probe cover is a thin plastic sheath. The assembly is inserted into ear canal 2 of ear 1. Distal end 10 of probe 5 receives IR emission from ear drum 3 and passes it to the IR sensor (not shown). FIG. 2 shows a cross-sectional view of probe 5 inserted into ear canal 2. IR sensor 8 and waveguide 9 are located inside the probe. These two components must be protected from heat that may be conducted from body tissue 15 through thin probe cover 6 and wall 11 of probe 5. Since body tissue 15 makes an intimate contact at area 16 with the outer surface of probe 5, heat relatively easily is conducted through wall 11 to waveguide 9 and subsequently to sensor 8. Air gap 18 between waveguide 9 and wall 11 helps reducing heat transfer but usually is not sufficient for a reliable thermal insulation. An air gap may be increased only on the expense of the wall 11 thickness that, in turn, will lead to reduction of a mechanical integrity and strength of probe 5.

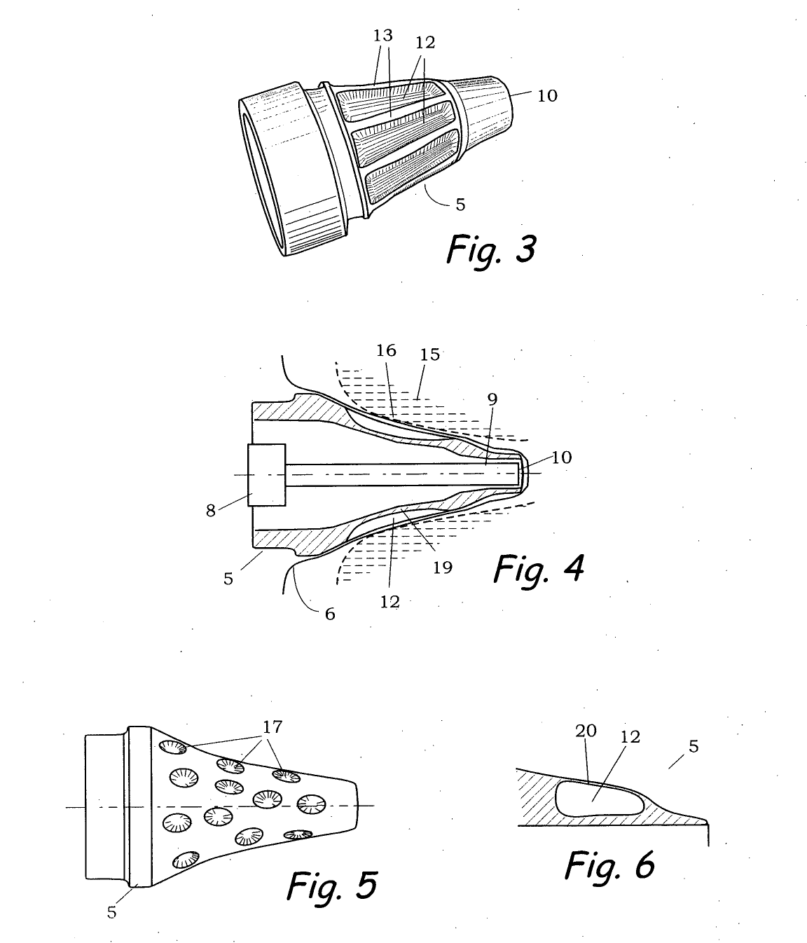

In the present invention, thermal insulation is improved as illustrated in FIG. 3. The outer surface of probe 5 contains at least one and preferably numerous cavities 12 separated by ridges 13. The overall profile of probe 5 is substantially the same as in the prior art (frustum, e.g.), except that the outer surface is not continuously smooth but has cavities, holes or indentations. FIG. 4 illustrates how the cavities improve thermal insulation. When probe 5 is covered with probe cover 6, cavities 12 form air pockets that separate body tissue 15 from thin wall 19. Since air is poor heat conductor, the air pockets formed by cavities 12 substantially reduce the lateral spurious conductive heat transfer from the ear canal to waveguide 9 and sensor 8. A probe cover, while usually is beneficial, is not essential for the cavities to reduce the thermal conductivity across the probe. This is because the air pockets still will be formed by the skin of body tissue 15.

In some applications, especially when the outer surface is desirable to be smooth and no protective probe covers are employed, the cavity may be permanently covered with a layer of plastic skin. That skin is molded, welded, glued or otherwise attached to the probe outer surface, thus forming a smooth surface without indentations. Thus, a cavity becomes enclosed inside the probe wall, as illustrated in FIG. 6. As a result, cavity 12 is encapsulated by skin 20, trapping gas (air) inside the cavity and improving thermal insulation.

A mechanical integrity of probe 5 is preserved due to relatively thick ridges 13 situated between cavities 12 as shown in FIG. 3. Naturally, a number of cavities and ridges can be any practical. The shapes of the cavities may vary depending on the overall shape of the probe, type of the probe cover and materials used. An example of a possible modification is shown in FIG. 5 illustrating multiple indentations 17 that are either orderly or randomly located on probe 5. The depth of the indentations (cavities) may range from as small as 0.5 mm to the entire thickness of the probe wall, forming the openings or holes in the probe surface. This, however in most cases may not be practical. Naturally, the deeper the indentations or cavities and the larger surface area of the probe surface they occupy the better thermal insulation.

While particular embodiments of the invention have been shown and described herewith for an ear thermometer, it will be obvious to those skilled in the art that other medical probes and changes and modifications to the illustrated embodiment may be made without departing from the invention in its broader aspects, and, therefore, the aim in the appended claims is to cover all such changes and modifications as fall within the true spirit and scope of the invention.

1. A probe of a medical instrument that is intended for insertion into a patient's body orifice, such probe has an inner surface and the outer surface which is shaped to contain at least one cavity encircled by a ridge.

2. A probe of claim 1 where said cavity is covered by outer thin skin that is permanently attached to said ridge.

3. (Cancelled)

4. A probe of claim 1 which contains multiple cavities being randomly distributed along said outer surface.

5. A probe of claim 1 is fabricated of material having low thermal conductivity

6. A probe of claim 1 further comprises a polymer probe cover that envelopes said outer surface.

7. A method of thermal insulation of a medical probe, comprising a step of forming indentations on the outer surface of the probe.

8. A method of thermal insulation of a medical probe of claim 7, further comprising a step of covering said indentations with a layer of thin protective material having low thermal conductivity.
